(19) United States
(12) Patent Application Publication
(10) Pub. No.: US 2024/0020346 A1
(43) Pub. Date: Jan. 18, 2024

(54) DEVICE AND METHOD FOR RECOMMENDING EDUCATIONAL CONTENT BASED ON USER'S SEARCH INFORMATION

(71) Applicant: RIIID INC., Seoul (KR)

(72) Inventors: Hyun Bin LOH, Seoul (KR); Tae Young CHOI, Yongin-si (KR)

(73) Assignee: RIIID INC., Seoul (KR)

(21) Appl. No.: 18/352,361

(22) Filed: Jul. 14, 2023

(30) Foreign Application Priority Data
Jul. 14, 2022 (KR) 10-2022-0086667

(51) Int. Cl. G06F 16/954; G06F 16/9538; G06F 16/951; G06F 40/40

(52) U.S. Cl. CPC G06F 16/954; G06F 16/9538; G06F 16/951; G06F 40/40

(57) ABSTRACT

Provided are a device and method for recommending educational content. The method includes acquiring a user's search information, acquiring a candidate webpage set on the basis of the search information, classifying candidate webpages included in the candidate webpage set into a first webpage group and a second webpage group, determining a target webpage on the basis of classification results, and transmitting the determined target webpage.

### CROSS-REFERENCE TO RELATED APPLICATION

This application claims priority to and the benefit of Korean Patent Application No. 10-2022-0086667, filed on Jul. 14, 2022, the disclosure of which is incorporated herein by reference in its entirety.

### BACKGROUND

### 1. Field of the Invention

The present disclosure relates to a device, system, and method for recommending educational content. More specifically, the present disclosure relates to a device, system, and method for recommending educational content on the basis of a user's search information of.

### 2. Discussion of Related Art

With the development of artificial intelligence (AI) technologies, the field of educational technology for diagnosing a user's learning ability and recommending educational content on the basis of the diagnosis result is attracting attention. In particular, there is a demand for a technology for providing optimal solution content or an optimal webpage to a user in consideration of the user's level of understanding.

However, the related arts aim at providing only solutions to problems or selecting only webpages with high reliability on the basis of a user's search information. In addition, research is ongoing on a technology for training a neural network model for calculating a user's learning ability information on the basis of the user's search information to calculate learning ability information, and recommending educational content on the basis of the learning ability information. However, building a neural network model for calculating a user's learning ability information on the basis of the user's search information requires enormous costs and time and is very difficult, which are realistic limitations.

Accordingly, it is necessary to develop a new educational content recommendation device and method for providing optimal educational content to a user according to the user's search information.

### SUMMARY OF THE INVENTION

The present disclosure is directed to providing an educational content recommendation device, system, and method for determining educational content which is highly relevant to a user's search information.

Technical problems to be achieved by the present disclosure are not limited to that described above, and other technical problems which have not been described will be clearly understood by those skilled in the technical field to which the present disclosure pertains from the present specification and the accompanying drawings.

According to an aspect of the present disclosure, there is provided a method of recommending educational content, the method including acquiring a user's search information, acquiring a candidate webpage set on the basis of the search information, classifying candidate webpages included in the candidate webpage set into a first webpage group and a second webpage group, determining a target webpage on the basis of classification results, and transmitting the determined target webpage. The classifying of the candidate webpages into the first webpage group and the second webpage group further includes analyzing content of the candidate webpages through a language model, generating a first classification question according to analysis results, and classifying the candidate webpages into the first webpage group and the second webpage group on the basis of the generated first classification question.

According to another aspect of the present disclosure, there is provided a device for recommending educational content, the device including a transceiver configured to communicate with a user terminal and a controller configured to acquire a user's search information through the transceiver and determine a target webpage on the basis of the search information. The controller acquires the user's search information, acquires a candidate webpage set on the basis of the search information, classifies candidate webpages included in the candidate webpage set into a first webpage group and a second webpage group, determines the target webpage on the basis of classification results, and transmits the determined target webpage. To classify the candidate webpages included in the candidate webpage set into the first webpage group and the second webpage group, the controller analyzes content of the candidate webpages through a language model, generates a classification question according to analysis results, and classifies the candidate webpages into the first webpage group and the second webpage group on the basis of the generated classification question.

Technical solutions of the present disclosure are not limited to those described above, and other technical solutions which have not been described will be clearly understood by those skilled in the technical field to which the present disclosure pertains from the present specification and the accompanying drawings.

### BRIEF DESCRIPTION OF THE DRAWINGS

The above and other aspects of the present disclosure will become more apparent to those of ordinary skill in the art by describing exemplary embodiments thereof in detail with reference to the accompanying drawings, in which:

FIG. 1 is a schematic block diagram of an educational content recommendation system according to an exemplary embodiment of the present disclosure;

FIG. 2 is a diagram illustrating operations of an educational content recommendation device according to an exemplary embodiment of the present disclosure;

FIG. 3 is a flowchart illustrating an educational content recommendation method according to an exemplary embodiment of the present disclosure;

FIG. 4 is a detailed flowchart of operation S3000 according to an exemplary embodiment of the present disclosure;

FIG. 5 is a diagram illustrating a process of classifying candidate webpages according to an exemplary embodiment of the present disclosure;

FIG. 6 is a detailed flowchart of operation S3200 according to an exemplary embodiment of the present disclosure;

FIG. 7 is a diagram illustrating a process of generating a classification question on the basis of a Gini index according to an exemplary embodiment of the present disclosure;

FIG. 8 is a detailed flowchart of operation S3300 according to an exemplary embodiment of the present disclosure; and

FIG. 9 is a diagram illustrating a process of classifying candidate webpages through next token prediction according to an exemplary embodiment of the present disclosure.

### DETAILED DESCRIPTION OF EXEMPLARY EMBODIMENTS

The above-described features and advantages of the present disclosure will become more apparent from the following detailed description related to the accompanying drawings. However, the present disclosure may be modified in various ways and may have various embodiments, and specific embodiments will be illustrated in the drawings and described in detail below.

Throughout the specification, the same reference numerals are used to designate the same components in principle. In addition, components having the same function within the scope of the same idea shown in the drawing of each embodiment will be described using the same reference numerals, and the overlapping description thereof will be omitted.

When it is determined that the detailed description of a known function or configuration related to the present invention may unnecessarily obscure the subject matter of the present disclosure, the detailed description will be omitted. In addition, numerals (e.g., first, second, etc.) used in the description of the present disclosure are merely identifiers for distinguishing one component from another.

The terms “module” and “unit” for components used in the following embodiments are given or interchangeably used in consideration of only ease of drafting the specification and do not have distinct meanings or roles from each other.

In the following embodiments, the singular forms include the plural forms unless the context clearly indicates otherwise.

In the following embodiments, the terms “comprises,” “comprising,” “includes,” “including,” “has,” “having,” etc. indicate the presence of features or components stated herein and do not preclude the possibility of presence or addition of one or more other features or components.

In the drawings, the sizes of components may be exaggerated or reduced for the convenience of description. For example, the size and thickness of each component shown in the drawings are arbitrarily shown for the convenience of description, and thus the present invention is not necessarily limited to those shown in the drawings.

When a certain embodiment can be implemented differently, a specific process may be performed in a different order from that described. For example, two processes described in succession may be performed substantially simultaneously or performed in a reverse order of that described.

In the following embodiments, when components and the like are referred to as being connected, the components may be directly connected or indirectly connected with components interposed therebetween.

For example, when components and the like are referred to as being electrically connected herein, the components and the like may be directly and electrically connected or may be indirectly and electrically connected with a component or the like interposed therebetween.

A method of recommending educational content according to an exemplary embodiment of the present disclosure may include an operation of acquiring a user's search information, an operation of acquiring a candidate webpage set on the basis of the search information, an operation of classifying candidate webpages included in the candidate webpage set into a first webpage group and a second webpage group, an operation of determining a target webpage on the basis of classification results, and an operation of transmitting the determined target webpage. The operation of classifying the candidate webpages into the first webpage group and the second webpage group may include an operation of analyzing content of the candidate webpages through a language model, an operation of generating a first classification question according to analysis results, and an operation of classifying the candidate webpages into the first webpage group and the second webpage group on the basis of the generated first classification question.

According to an exemplary embodiment of the present disclosure, the first classification question may be a question generated to minimize the difference between the number of candidate webpages classified into the first webpage group and the number of candidate webpages classified into the second webpage group.

According to an exemplary embodiment of the present disclosure, the operation of generating the first classification question may include an operation of generating a first question on the basis of the analysis results and acquiring a first Gini index between the candidate webpages included in the candidate webpage set and the first question on the basis of the content of the candidate webpages, an operation of generating a second question on the basis of the analysis results and acquiring a second Gini index between the candidate webpages included in the candidate webpage set and the second question on the basis of the content of the candidate webpages, and an operation of comparing the first Gini index and the second Gini index and determining any one of the first question and the second question as the first classification question on the basis of a comparison result.

According to an exemplary embodiment of the present disclosure, the operation of determining any one of the first question and the second question as the first classification question may further include an operation of determining a question corresponding a Gini index having a larger value between the first Gini index and the second Gini index as the first classification question.

According to an exemplary embodiment of the present disclosure, the operation of classifying the candidate webpages into the first webpage group and the second webpage group on the basis of the generated first classification question may further include an operation of calculating whether the content of the candidate webpages corresponds to the generated first classification question through next token prediction and an operation of classifying the candidate webpages into the first webpage group when the content of the candidate webpages corresponds to the generated first classification question, and classifying the candidate webpages into the second webpage group when the content of the candidate webpages does not correspond to the generated first classification question.

According to an exemplary embodiment of the present disclosure, the operation of determining the target webpage on the basis of the classification results may include an operation of generating a second classification question according to analysis results of content of candidate webpages included in the first webpage group, an operation of classifying the candidate webpages included in the first webpage group into a third webpage group and a fourth webpage group on the basis of the generated second classification question, and an operation of determining a candidate webpage included in any one of the third webpage group and the fourth webpage group as the target webpage on the basis of classification results.

According to an exemplary embodiment of the present disclosure, the second classification question may be a question generated to minimize the difference between the number of candidate webpages classified into the third webpage group and the number of candidate webpages classified into the fourth webpage group.

According to an exemplary embodiment of the present disclosure, a program for performing the method of recommending educational content may be recorded on a computer-readable recording medium.

A device for recommending educational content according to an exemplary embodiment of the present disclosure may include a transceiver which communicates with a user terminal and a controller which acquires a user's search information through the transceiver and determines a target webpage on the basis of the search information. The controller acquires the user's search information, acquires a candidate webpage set on the basis of the search information, classifies candidate webpages included in the candidate webpage set into a first webpage group and a second webpage group, determines the target webpage on the basis of classification results, and transmits the determined target webpage. To classify the candidate webpages included in the candidate webpage set into the first webpage group and the second webpage group, the controller analyzes content of the candidate webpages through a language model, generates a classification question according to analysis results, and classifies the candidate webpages into the first webpage group and the second webpage group on the basis of the generated classification question.

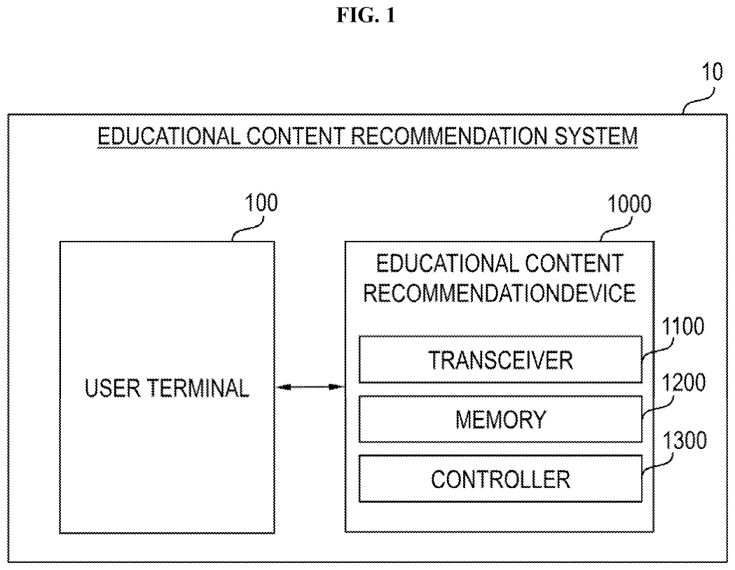

Hereinafter, a device, system, and method for recommending educational content according to exemplary embodiments of the present disclosure will be described with reference to FIGS. 1 to 9.

FIG. 1 is a schematic block diagram of an educational content recommendation system according to an exemplary embodiment of the present disclosure.

The educational content recommendation system 10 according to an exemplary embodiment of the present disclosure may include a user terminal 100 and an educational content recommendation device 1000.

The user terminal 100 may acquire a question database from the educational content recommendation device 1000 or an arbitrary external device. For example, the user terminal 100 may receive some questions included in the question database and display the received questions to a user. Subsequently, the user may input answers to the displayed questions to the user terminal 100. The user terminal 100 may acquire study data on the basis of the user's answers and transmit the study data of the user to the educational content recommendation device 1000. Here, the study data may include identification information of questions answered by the user, the user's answer information for the question, correct or wrong answer information, etc. Meanwhile, the user terminal 100 may transmit identification information of the user to the educational content recommendation device 1000.

Also, the user terminal 100 may acquire the user's search information and transmit the user's search information to the educational content recommendation device 1000. Here, the search information may include log data related to the user's search, identification information of a question related to the search, a search query, and any type of information resulting from the search query. The log data may include data of a time at which the search is performed, data of a browsing time of search results, etc. The question identification information may include any information indicating a question searched for by the user.

Also, the user terminal 100 may receive a classification question from the educational content recommendation device 1000. Here, the user terminal 100 may acquire the user's answer to the classification question and transmit the user's answer to the educational content recommendation device 1000. Further, the user terminal 100 may receive recommendation content from the educational content recommendation device 1000 and display the received recommendation content to the user. Here, the recommendation content may be any education-related content, such as an education-related webpage, a solution to a question related to a search, a recommendation question, etc., acquired on the basis of search information.

The educational content recommendation device 1000 according to the exemplary embodiment of the present disclosure may include a transceiver 1100, a memory 1200, and a controller 1300.

The transceiver 1100 may communicate with any external device including the user terminal 100. For example, the educational content recommendation device 1000 may receive study data of the user, the identification information of the user, and/or search information from the user terminal 100 or transmit a classification question and recommendation content to the user terminal 100.

The educational content recommendation device 1000 may access a network through the transceiver 1100 to transmit and receive various types of data. The transceiver 1100 may roughly be of a wired type or a wireless type. Since the wired type and wireless type have their own merits and demerits, the educational content recommendation device 1000 may have both the wired type and wireless type of transceivers 1100. Here, in the case of the wireless type, a wireless local area network (WLAN)-type communication method, such as WiFi, may be mainly used. Alternatively, in the case of the wireless type, a cellular communication method, such as Long Term Evolution (LTE) or fifth generation (5G), may be used. However, a wireless communication protocol is not limited to the foregoing examples, and any appropriate wireless communication method may be used. In the case of the wired type, LAN or Universal Serial Bus (USB) communication is a representative example, and other methods are also available.

The memory 1200 may store various types of information. In the memory 1200, various types of data may be temporarily or semi-permanently stored. Examples of the memory 1200 may be a hard disk drive (HDD), a solid state drive (SSD), a flash memory, a read-only memory (ROM), a random access memory (RAM), etc. The memory 1200 may be provided to be embedded in the educational content recommendation device 1000 or detachably attached to the educational content recommendation device 1000. The memory 1200 may store an operating system (OS) for running the educational content recommendation device 1000, a program for driving each component of the educational content recommendation device 1000, and various types of data required for operations of the educational content recommendation device 1000.

The controller 1300 may control overall operations of the educational content recommendation device 1000. For example, the controller 1300 may control the overall operations of the educational content recommendation device 1000 including an operation of acquiring a user's search information, an operation of acquiring a candidate webpage set, an operation of classifying candidate webpages included in the candidate webpage set, an operation of determining a target webpage on the basis of classification results, etc. which will be described below. Specifically, the controller 1300 may load a program for overall operations of the educational content recommendation device 1000 from the memory 1200 and execute the program. The controller 1300 may be implemented as an application processor (AP), a central processing unit (CPU), or a device similar thereto according to hardware, software, or a combination thereof. Here, the controller 1300 may be provided as hardware in the form of an electronic circuit which performs a control function by processing an electrical signal, and provided as software in the form of a program or code which drives the hardware circuit.

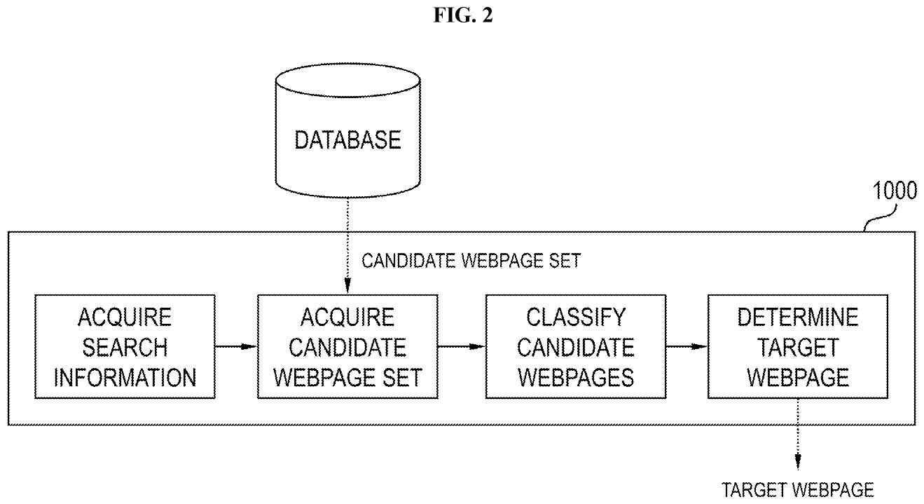

Operations of the educational content recommendation device 1000 and an educational content recommendation method according to exemplary embodiments of the present disclosure will be described in detail below with reference to FIGS. 2 to 9.

FIG. 2 is a diagram illustrating operations of the educational content recommendation device 1000 according to the exemplary embodiment of the present disclosure.

The educational content recommendation device 1000 according to the exemplary embodiment of the present disclosure may acquire a user's search information through the transceiver 1100. Here, the search information may include log data related to the user's search, identification information of a question related to the search, a search query, and any type of information resulting from the search query. Specifically, the educational content recommendation device 1000 may acquire the user's search information input to the user terminal 100 from the user terminal 100.

The educational content recommendation device 1000 according to the exemplary embodiment of the present disclosure may acquire a candidate webpage set including a plurality of candidate webpages through the transceiver 1100. Specifically, the educational content recommendation device 1000 may acquire a candidate webpage set including a plurality of candidate webpages stored in a database. For example, the educational content recommendation device 1000 may acquire a candidate webpage set on the basis of the user's search information. For example, the educational content recommendation device 1000 may acquire a candidate webpage set including candidate webpages including content related to the user's search information by searching the database on the basis of the user's search information.

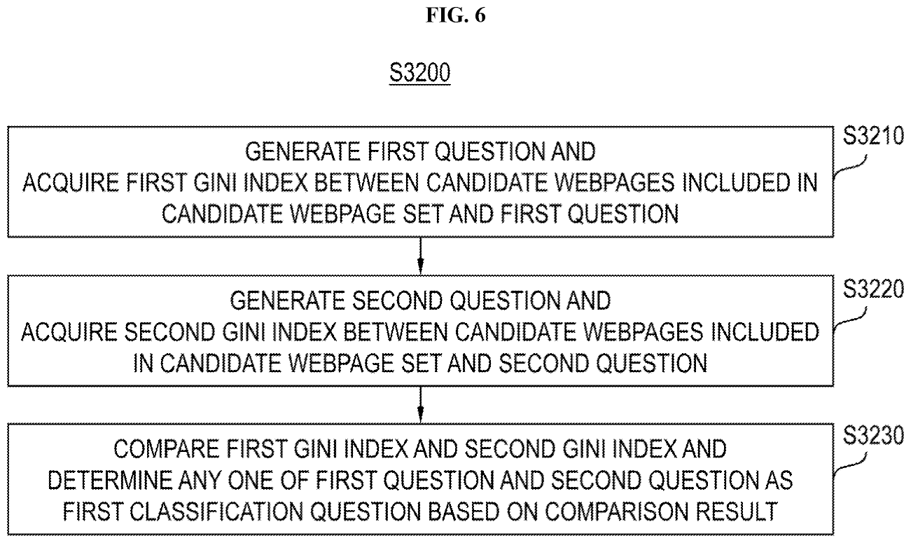

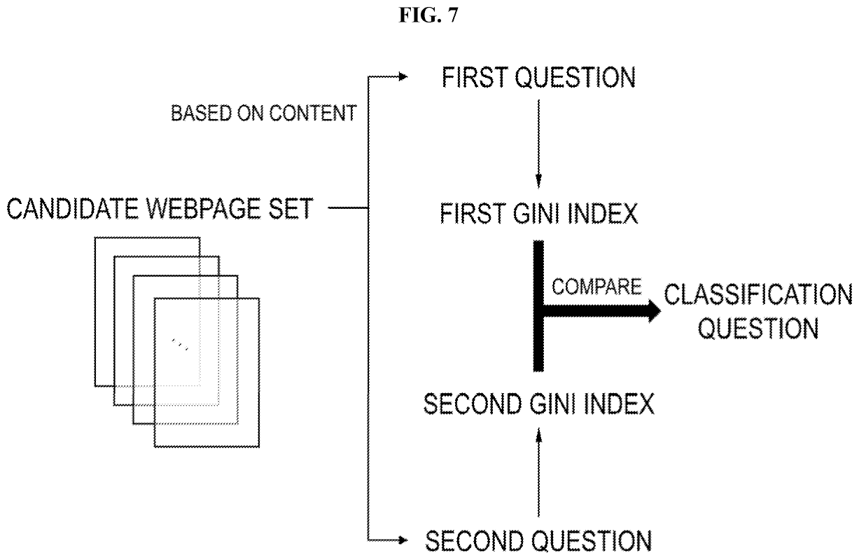

The educational content recommendation device 1000 according to the exemplary embodiment of the present disclosure may perform an operation of classifying the candidate webpages included in the candidate webpage set. Specifically, the educational content recommendation device 1000 may analyze content included in the candidate webpages, generate a classification question on the basis of analysis results, and classify the candidate webpages into a first webpage group and a second webpage group on the basis of the generated classification question. For example, the educational content recommendation device 1000 may analyze the content of the candidate webpages through a language model and generate a classification question on the basis of classification results. Here, the classification question may be a question generated to minimize the difference between the number of candidate webpages classified into the first webpage group and the number of candidate webpages classified into the second webpage group. Alternatively, the classification question may be a question generated so that the difference between the number of candidate webpages classified into the first webpage group and the number of candidate webpages classified into the second webpage group becomes a predetermined value or less. A process of generating the classification question will be described in further detail with reference to FIGS. 6 and 7.

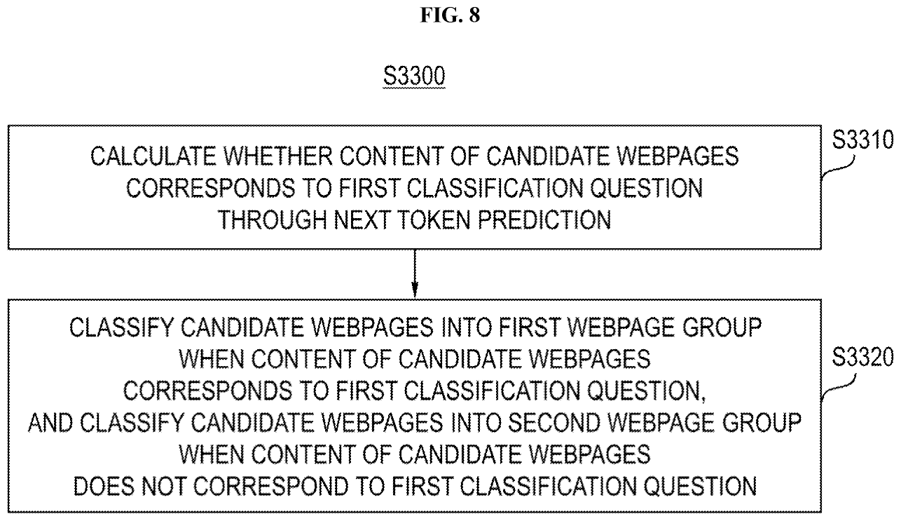

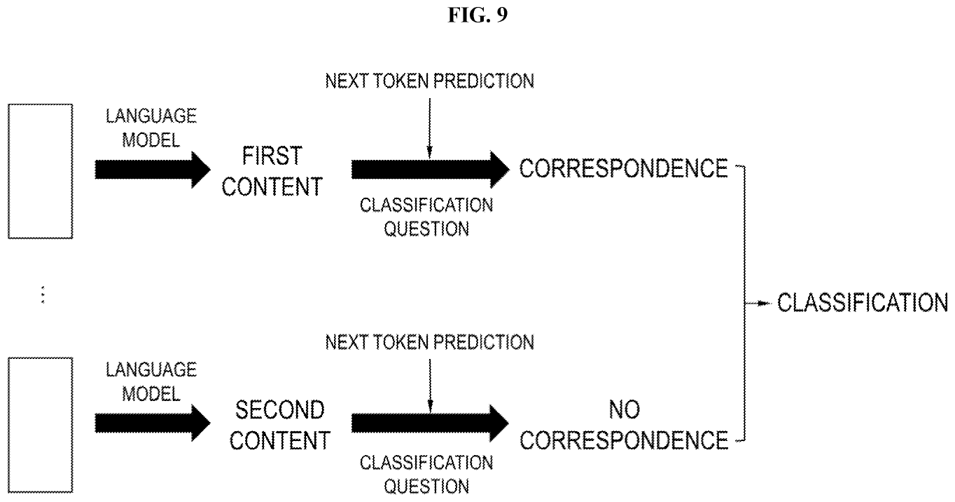

The educational content recommendation device 1000 may classify the candidate webpages into the first webpage group and the second webpage group on the basis of the classification question. Specifically, the educational content recommendation device 1000 may calculate whether the content of the candidate webpages corresponds to the generated classification question and classify the candidate webpages included in the candidate webpage set into the first webpage group and the second webpage group on the basis of calculation results. For example, the educational content recommendation device 1000 may calculate or determine whether the content of the candidate webpages corresponds to the classification question through next token prediction. Next token prediction may involve any algorithm for predicting a probability that second information is information subsequent to given first information. Here, the educational content recommendation device 1000 may be configured to classify the candidate webpages into the first webpage group when the content of the candidate webpages corresponds to or is related to the classification question, and to classify the candidate webpages into the second webpage group rather than the first webpage group when the content of the candidate webpages does not correspond to or is unrelated to the classification question. A process of classifying candidate webpages through next token prediction will be described in further detail with reference to FIGS. 8 and 9.

The educational content recommendation device 1000 according to the exemplary embodiment of the present disclosure may determine a target webpage from the candidate webpage set on the basis of classification results.

As an example, the educational content recommendation device 1000 may determine a target webpage by repeating the above operation of generating a classification question and classifying candidate webpages on the basis of the classification question a plurality of times. For example, the educational content recommendation device 1000 may generate a first classification question and classify the candidate webpages into the first webpage group and the second webpage group according to whether the content of the candidate webpages is related to the first classification question using the generated first classification question. Here, the educational content recommendation device 1000 may generate a second classification question and classify candidate webpages which are classified into the first webpage group (or the second webpage group) into a third webpage group and a fourth webpage group. For example, the educational content recommendation device 1000 may predict or calculate whether content of the candidate webpages corresponds to the second classification question through next token prediction and classify the candidate webpages into the third webpage group and the fourth webpage group. The educational content recommendation device 1000 may repeatedly perform such an operation of classifying candidate webpages a plurality of times, and in this case, the educational content recommendation device 1000 may determine a target webpage on the basis of classification results. In this way, the educational content recommendation device 1000 according to the exemplary embodiment of the present disclosure can select a target webpage which includes content highly relevant to a user's search information or optimal content for the user's search information.

Meanwhile, the educational content recommendation device 1000 according to the exemplary embodiment of the present disclosure may perform an operation of transmitting the determined target webpage to any external device (or any external server) including the user terminal 100 through the transceiver 1100.

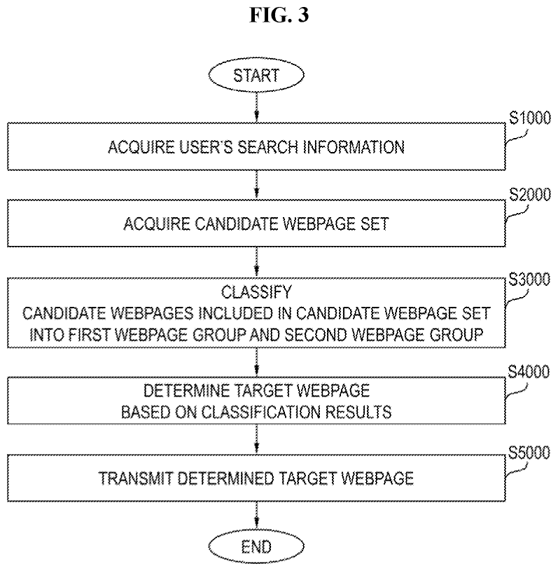

An educational content recommendation method according to an exemplary embodiment of the present disclosure will be described in further detail below with reference to FIGS. 3 to 9. The educational content recommendation method according to an exemplary embodiment of the present disclosure may be performed by the educational content recommendation device 1000. In describing the educational content recommendation method, some embodiments overlapping the above description may be omitted. However, this is just for convenience of description and is not to be interpreted as limiting.

FIG. 3 is a flowchart illustrating an educational content recommendation method according to an exemplary embodiment of the present disclosure.

The educational content recommendation method according to an exemplary embodiment of the present disclosure may include an operation S1000 of acquiring a user's search information, an operation S2000 of acquiring a candidate webpage set, an operation S3000 of classifying candidate webpages included in the candidate webpage set into a first webpage group and a second webpage group, an operation S4000 of determining a target webpage on the basis of classification results, and an operation S5000 of transmitting the determined target webpage.

In the operation S1000 of acquiring the user's search information, the educational content recommendation device 1000 may acquire the user's search information through the transceiver 1100. Here, the search information may include log data related to the user's search, identification information of a question related to the search, a search query, and any type of information resulting from the search query. Specifically, the educational content recommendation device 1000 may acquire the user's search information input to the user terminal 100 from the user terminal 100.

In the operation S2000 of acquiring a candidate webpage set, the educational content recommendation device 1000 may acquire a candidate webpage set including a plurality of candidate webpages through the transceiver 1100. Specifically, the educational content recommendation device 1000 may acquire the candidate webpage set including the plurality of candidate webpages from a database. For example, the educational content recommendation device 1000 may acquire a candidate webpage set of candidate webpages including content related to the user's search information by searching the database on the basis of the user's search information.

In the operation S3000 of classifying the candidate webpages included in the candidate webpage set into the first webpage group and the second webpage group, the educational content recommendation device 1000 may analyze the content of the candidate webpages included in the candidate webpage set. Further, in the operation S3000 of classifying the candidate webpages included in the candidate webpage set into the first webpage group and the second webpage group, the educational content recommendation device 1000 may generate a classification question on the basis of analysis results of the content of the candidate webpages and classify the candidate webpages into the first webpage group and the second webpage group on the basis of the classification question.

Specifically, the educational content recommendation device 1000 may generate a plurality of questions on the basis of the content included in the candidate webpages, acquire Gini indices between the candidate webpages and each question, and compare the Gini indices with each other to determine a classification question among the plurality of questions. A Gini index is an index obtained by quantifying a probability that a label other than a target label will be selected. A Gini index closer to 1 represents that a probability that a target label will be selected and a probability that another label will be selected are closer to equal. For example, the educational content recommendation device 1000 may generate a plurality of questions including a first question and a second question on the basis of each piece of content included in the candidate webpages. Here, the educational content recommendation device 1000 may acquire a first Gini index between the candidate webpages and the first question and a second Gini index between the candidate webpages and the second question and compare the first Gini index with the second Gini index to determine a classification question from between the first question and the second question.

Further, the educational content recommendation device 1000 may generate a classification question to minimize the difference between the number of candidate webpages classified into the first webpage group and the number of candidate webpages classified into the second webpage group (e.g., to substantially equalize the number of candidate webpages classified into the first webpage group and the number of candidate webpages classified into the second webpage group).

Here, the educational content recommendation device 1000 may classify the candidate webpages into the first webpage group and the second webpage group on the basis of the generated classification question. Specifically, the educational content recommendation device 1000 may calculate whether content included in the candidate webpages corresponds to the classification question or a probability that the content included in the candidate webpages will correspond to the classification question and classify the candidate webpages into the first webpage group and the second webpage group on the basis of calculation results.

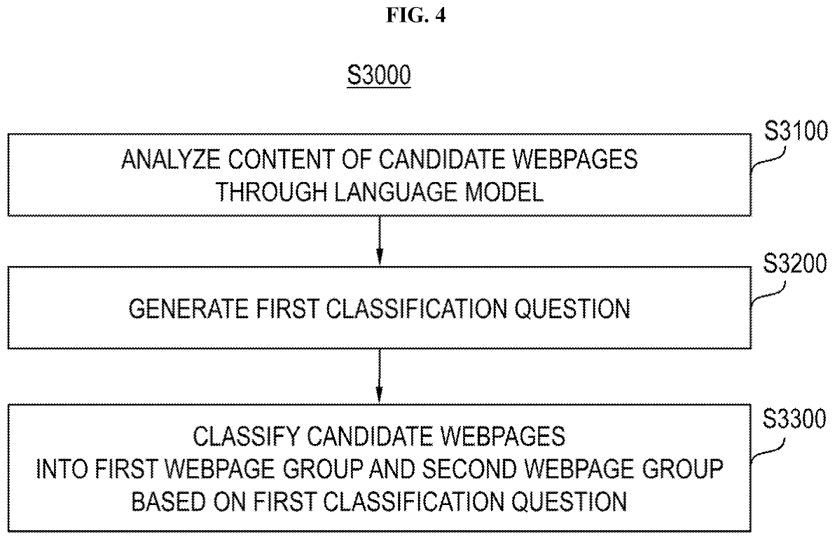

The operation S3000 of classifying the candidate webpages into the first webpage group and the second webpage group will be described in further detail with reference to FIGS. 4 to 9.

In the operation S4000 of determining the target webpage on the basis of the classification results, the educational content recommendation device 1000 may determine or select a target webpage which is educational content to be recommended to the user, on the basis of the classification results of the candidate webpages in the operation S3000.

Meanwhile, although not shown in FIG. 3, the educational content recommendation device 1000 according to the exemplary embodiment of the present disclosure may determine a target webpage by repeating the above operation of generating a classification question and classifying candidate webpages on the basis of the generated classification question a plurality of times. As described above, in the operation S3000, the educational content recommendation device 1000 may generate the first classification question and classify the candidate webpages into the first webpage group and the second webpage group using the generated first classification question. Here, the educational content recommendation device 1000 may additionally generate a second classification question according to analysis results of content of candidate webpages included in the first webpage group (or the second webpage group) and classify the candidate webpages classified into the first webpage group (or the second webpage group) into a third webpage group and a fourth webpage group. For example, the educational content recommendation device 1000 may generate a plurality of questions including a third question and a fourth question, acquire a third Gini index between the third question and the classified candidate webpages and a fourth Gini index between the fourth question and the classified candidate webpages and compare the third Gini index with the fourth Gini index to determine a second classification question from between the third question and the fourth question.

Further, the educational content recommendation device 1000 may additionally classify the classified candidate webpages into the third webpage group and the fourth webpage group on the basis of the second classification question. For example, the educational content recommendation device 1000 may calculate, through a next token prediction algorithm, whether content of the classified candidate webpages corresponds to the second classification question or a probability that the content of the classified candidate webpages will correspond to the second classification question and classify the classified candidate webpages into the third webpage group and the fourth webpage group on the basis of calculation results. Specifically, when content of the candidate webpages classified into the first webpage group (or the second webpage group) corresponds to the second classification question, the educational content recommendation device 1000 may classify the candidate webpages into the third webpage group. On the other hand, when the content of the candidate webpages classified into the first webpage group (or the second webpage group) does not correspond to the second classification question, the educational content recommendation device 1000 may classify the candidate webpages into the fourth webpage group. Meanwhile, like the first classification question, the second classification question may be a question generated so that the difference between the number of candidate webpages classified into the third webpage group and the number of candidate webpages classified into the fourth webpage group may be minimized or become a predetermined value or less.

In other words, although not shown in FIG. 3, the operation S4000 of determining the target webpage on the basis of the classification results according to an exemplary embodiment of the present disclosure may further include an operation of generating the second classification question according to the analysis results of the content of the candidate webpages included in the first webpage group (or the second webpage group), an operation of classifying the candidate webpages included in the first webpage group (or the second webpage group) into the third webpage group and the fourth webpage group on the basis of the generated second classification question, and an operation of determining a candidate webpage included in any one of the third webpage group and the fourth webpage group as the target webpage on the basis of classification results.

In the operation S5000 of transmitting the determined target webpage, the educational content recommendation device 1000 may transmit the determined target webpage to any external device (or any external server) including the user terminal 100 through the transceiver 1100.

The operation S3000 of classifying the candidate webpages included in the candidate webpage set into the first webpage group and the second webpage group will be described in further detail below with reference to FIGS. 4 to 9.

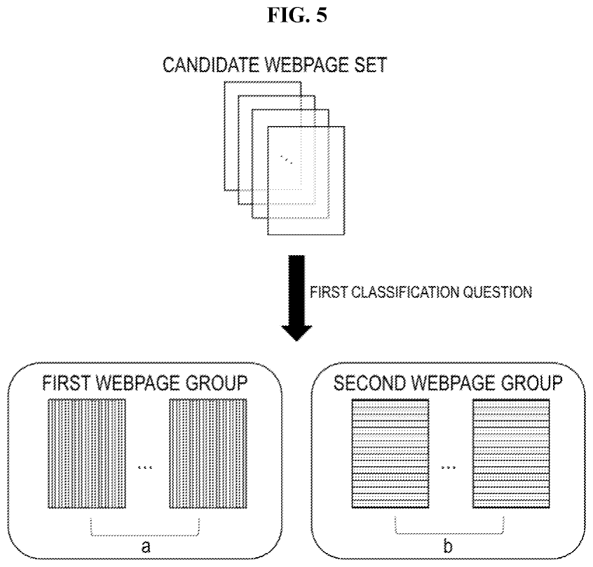

Refer to FIGS. 4 and 5. FIG. 4 is a detailed flowchart of operation S3000 according to an exemplary embodiment of the present disclosure. FIG. 5 is a diagram illustrating a process of classifying candidate webpages according to an exemplary embodiment of the present disclosure.

The operation S3000 of classifying the candidate webpages included in the candidate webpage set into the first webpage group and the second webpage group according to an exemplary embodiment of the present disclosure may further include an operation S3100 of analyzing the content of the candidate webpages through a language model, an operation S3200 of generating a first classification question, and an operation S3300 of classifying the candidate webpages into the first webpage group and the second webpage group on the basis of the first classification question.

In the operation S3100 of analyzing the content of the candidate webpages through the language model, the educational content recommendation device 1000 may analyze the content of the candidate webpages through the language model (e.g., Generative Pretrained Transformer 3 (GPT-3) or Bidirectional Encoder Representations from Transformers (BERT)). For example, the language model may acquire data of content included in a candidate webpage and output analysis results on the basis of the data of content. Here, the educational content recommendation device 1000 may acquire analysis results of the content of the candidate webpages.

In the operation S3200 of generating the first classification question, the educational content recommendation device 1000 may generate the first classification question. Specifically, the educational content recommendation device 1000 may generate the first classification question that is a criterion for classifying the candidate webpages. For example, the educational content recommendation device 1000 may generate the first classification question to minimize the difference between the number (e.g., a in FIG. 5) of candidate webpages classified into the first webpage group and the number (e.g., b in FIG. of candidate webpages classified into the second webpage group (e.g., or to substantially equalize the number of candidate webpages classified into the first webpage group and the number of candidate webpages classified into the second webpage group) or may train artificial intelligence (AI) for generating such a first classification question.

As an example, the educational content recommendation device 1000 may generate or determine a classification question using Gini indices. For example, the educational content recommendation device 1000 may generate a plurality of questions including the first question and the second question on the basis of the content information of the candidate webpages included in the candidate webpage set. Here, the educational content recommendation device 1000 may acquire a first Gini index between the content of the candidate webpages and the first question and a second Gini index between the content of the candidate webpages and the second question, compare the first Gini index and the second Gini index, and determine the first classification question from between the first question and the second question on the basis of a comparison result. For example, the educational content recommendation device 1000 may compare the first Gini index and the second Gini index and determine a question corresponding to a Gini index having a larger value from between the first Gini index and the second Gini index as the first classification question.

For example, the educational content recommendation device 1000 may generate or determine the first classification question to minimize the difference between the number (a) of candidate webpages including content corresponding to the first classification question and the number (b) of candidate webpages not including content corresponding to the first classification question (or to substantially equalize the number of candidate webpages classified into the first webpage group and the number of candidate webpages classified into the second webpage group). Specifically, the educational content recommendation device 1000 may generate a first question and a second question and calculate whether the content of the candidate webpages included in the candidate webpage set corresponds to the first question and whether the content of the candidate webpages included in the candidate webpage set corresponds to the second question through the foregoing next token prediction algorithm. Here, the educational content recommendation device 1000 may calculate a first difference between the number of candidate webpages including content corresponding to the first question and the number of candidate webpages not including content corresponding to the first question and a second difference between the number of candidate webpages including content corresponding to the second question and the number of candidate webpages not including content corresponding to the second question, compare the first difference and the second difference, and determine a question having a smaller difference value as the first classification question.

However, this is just an example, and the educational content recommendation device 1000 may generate the first classification question to minimize the difference between the number of candidate webpages classified into the first webpage group and the number of candidate webpages classified into the second webpage group using any appropriate method.

In the operation S3300 of classifying the candidate webpages into the first webpage group and the second webpage group on the basis of the first classification question, the educational content recommendation device 1000 may classify the candidate webpages into the first webpage group and the second webpage group using the first classification question generated through operation S3200.

For example, the educational content recommendation device 1000 may determine or predict whether the content of the candidate webpages corresponds to the first classification question on the basis of analysis results of the candidate webpages. For example, the educational content recommendation device 1000 may calculate a probability that the content of the candidate webpages will correspond to the first classification question or whether the content of the candidate webpages will correspond to the first classification question using the next token prediction algorithm. Here, the educational content recommendation device 1000 may classify the candidate webpages into the first webpage group when the content of the candidate webpages corresponds to the first classification question, and may classify the candidate webpages into the second webpage group when the content of the candidate webpages does not correspond to the first classification question. Alternatively, the educational content recommendation device 1000 may classify the candidate webpages into the first webpage group when the probability that the content of the candidate webpages will correspond to the first classification question is a predetermined value or more, and may classify the candidate webpages into the second webpage group when the probability that the content of the candidate webpages will correspond to the first classification question is smaller than the predetermined value. A process of classifying candidate webpages using a next token prediction algorithm will be described in detail with reference to FIGS. 8 and 9.

A process of generating a first classification question according to an exemplary embodiment of the present disclosure will be described in detail below with reference to FIGS. 6 and 7. FIG. 6 is a detailed flowchart of operation S3200 according to an exemplary embodiment of the present disclosure. FIG. 7 is a diagram illustrating a process of generating a classification question on the basis of a Gini index according to an exemplary embodiment of the present disclosure.

Operation S3200 of generating the first classification question according to an exemplary embodiment of the present disclosure may further include an operation S3210 of generating a first question and acquiring a first Gini index between the candidate webpages included in the candidate webpage set and the first question, an operation S3220 of generating a second question and acquiring a second Gini index between the candidate webpages included in the candidate webpage set and the second question, and an operation S3230 of comparing the first Gini index and the second Gini index and determining any one of the first question and the second question as the first classification question on the basis of a comparison result.

In the operation S3210 of generating the first question and acquiring the first Gini index between the candidate webpages included in the candidate webpage set and the first question, the educational content recommendation device 1000 may generate the first question on the basis of the content information of the candidate webpages included in the candidate webpage set. Here, the educational content recommendation device 1000 may acquire the first Gini index between the content of the candidate webpages included in the candidate webpage set and the generated first question.

In the operation S3220 of generating the second question and acquiring the second Gini index between the candidate webpages included in the candidate webpage set and the second question, the educational content recommendation device 1000 may generate the second question on the basis of the content information of the candidate webpages included in the candidate webpage set. Here, the educational content recommendation device 1000 may acquire the second Gini index between the content of the candidate webpages included in the candidate webpage set and the generated second question.

In the operation S3230 of comparing the first Gini index and the second Gini index and determining any one of the first question and the second question as the first classification question on the basis of a comparison result, the educational content recommendation device 1000 may compare the first Gini index and the second Gini index and determine the first classification question from between the first question and the second question on the basis of a comparison result. For example, the educational content recommendation device 1000 may compare the first Gini index and the second Gini index and determine, as the first classification question, a question corresponding to a Gini index having larger values from between the first Gini index and the second Gini index. However, this is just an example, and the educational content recommendation device 1000 may determine a classification question using any appropriate method. For example, the educational content recommendation device 1000 may acquire Gini indices between each of a plurality of questions and the candidate webpages, arrange the plurality of questions in order of Gini index, and determine or generate a question corresponding to the highest Gini index as a classification question.

A process of classifying candidate webpages according to an exemplary embodiment of the present disclosure will be described in detail below with reference to FIGS. 8 and 9. FIG. 8 is a detailed flowchart of operation S3300 according to an exemplary embodiment of the present disclosure. FIG. 9 is a diagram illustrating a process of classifying candidate webpages through next token prediction according to an exemplary embodiment of the present disclosure.

Operation S3300 of classifying the candidate webpages into the first webpage group and the second webpage group on the basis of the first classification question may further include an operation S3310 of calculating whether the content of the candidate webpages corresponds to the first classification question through next token prediction and an operation S3210 of classifying the candidate webpages into the first webpage group when the content of the candidate webpages corresponds to the first classification question and classifying the candidate webpages into the second webpage group when the content of the candidate webpages does not correspond to the first classification question.

In the operation S3310 of calculating whether the content of the candidate webpages corresponds to the first classification question through next token prediction, the educational content recommendation device 1000 may predict or calculate whether the content information of the candidate webpages corresponds to the first classification question or a probability that the content information of the candidate webpages corresponds to the first classification question using next token prediction. Specifically, the educational content recommendation device 1000 may calculate a probability that the content information of the candidate webpages will correspond to the first classification question on the basis of the first classification question and the content information of the candidate webpages. For example, the educational content recommendation device 1000 may calculate a probability that first content of a first candidate webpage will correspond to the first classification question or whether the first content of the first candidate webpage corresponds to the first classification question. For example, the educational content recommendation device 1000 may calculate a probability that second content of a second candidate webpage will correspond to the first classification question or whether the second content of the second candidate webpage corresponds to the first classification question. Specifically, when the user's search information is related to “the origin of the universe,” classification questions, such as “do you know the law of energy conservation?” and/or “do you want a religious explanation?” may be generated. Here, the educational content recommendation device 1000 may calculate whether the content information included in the candidate webpages corresponds to the classification questions or probabilities that the content information included in the candidate webpages will be related to the classification questions.

In the operation S3320 of classifying the candidate webpages into the first webpage group when the content of the candidate webpages corresponds to the first classification question and classifying the candidate webpages into the second webpage group when the content of the candidate webpages does not correspond to the first classification question, the educational content recommendation device 1000 may classify the candidate webpages into the first webpage group when the content of the candidate webpages corresponds to the first classification question or a probability that the content of the candidate webpages will be related to the first classification question is calculated to be a predetermined value or more. On the other hand, the educational content recommendation device 1000 may classify the candidate webpages into the second webpage group when the content of the candidate webpages does not correspond to the first classification question or the probability that the content of the candidate webpages will be related to the first classification question is calculated to be smaller than the predetermined value.

For example, the classification question “do you know the law of energy conservation?” may be generated according to the user's search information related to “the origin of the universe.” In this case, when content of a candidate webpage includes content related to the law of energy conservation or a probability that the content of the candidate webpage will be related to the law of energy conservation is the predetermined value or more, the educational content recommendation device 1000 may classify the candidate webpage into the first webpage group. On the other hand, when the content of the candidate webpage does not include content related to the law of energy conservation or the probability that the content of the candidate webpage will be related to the law of energy conservation is smaller than the predetermined value, the educational content recommendation device 1000 may classify the candidate webpage into the second webpage group.

However, the above example is just for convenience of description and is not to be interpreted as limiting. The educational content recommendation device 1000 may classify candidate webpages using any classification question generated according to any user's search information.

Meanwhile, the educational content recommendation device 1000 may provide the generated classification information to the user terminal 100, acquire the user's answer to the classification question from the user terminal 100, and classify candidate webpages into the first webpage group and the second webpage group on the basis of the user's answer. For example, when a classification question, such as “what level of explanation do you want?” is generated for the user's search information about the concept of differentiation and integration, the educational content recommendation device 1000 may acquire the user's answer corresponding to any one of a first answer (e.g., a level of high school students or lower), a second answer (e.g., a level of university students not majoring in mathematics or higher), and a third answer (e.g., a level of people majoring in mathematics) through the user terminal 100 and classify or filter the candidate webpages on the basis of the user's answer.

Meanwhile, as described above, the educational content recommendation device 1000 according to the exemplary embodiment of the present disclosure may perform an operation of generating a classification question and classifying candidate webpages according to whether the candidate webpages correspond to the generated classification question a plurality of times. For example, the educational content recommendation device 1000 may generate an additional classification question, such as “is the answer related to religion?” for candidate webpages which are classified into the first webpage group because they include content related to the law of energy conservation, calculate whether the candidate webpages correspond to the additional classification question or a probability that the candidate webpages will correspond to the additional classification question, and classify the candidate webpages classified into the first webpage group into the third webpage group and the fourth webpage group. Further, the educational content recommendation device 1000 may repeatedly perform an operation of classifying candidate webpages a predetermined number of times, and finally, the educational content recommendation device 1000 may acquire a target webpage on the basis of classification results. Also, the educational content recommendation device 1000 may perform an operation of transmitting the target webpage to any external device (or any external server) including the user terminal 100 through the transceiver 1100.

Various operations of the educational content recommendation device 1000 described above may be stored in the memory 1200 of the educational content recommendation device 1000, and the controller 1300 of the educational content recommendation device 1000 may perform the operations stored in the memory 1200.

With the device and method for recommending educational content according to exemplary embodiments of the present disclosure, it is possible to select a target webpage including content highly relevant to a user's search information or the most appropriate content for the user's level of understanding.

With the device and method for recommending educational content according to exemplary embodiments of the present disclosure, it is possible to rapidly acquire an appropriate target webpage for a user by generating a classification question.

Effects of the present disclosure are not limited to those described above, and other effects which have not been described will be clearly understood by those skilled in the technical field to which the present disclosure pertains from the above description.

The features, structures, effects, etc. described in the exemplary embodiments are included in at least one embodiment of the present invention and are not necessarily limited to one embodiment. Further, the features, structures, effects, etc. provided in each embodiment can be combined or modified in other embodiments by those of ordinary skill in the art to which the embodiments pertain. Accordingly, content related to such combinations and modifications should be construed as being included in the scope of the present invention.

Although embodiments of the present invention have been described above, these are just examples and do not limit the present invention. Those skilled in the field to which the present disclosure pertains will be aware that several modifications and applications not illustrated above are possible without departing from the fundamental characteristics of the present disclosure. In other words, each component specified in the embodiments can be implemented in a modified form. Also, differences related to such variants and applications should be interpreted as falling within the scope of the present invention defined in the appended claims.

What is claimed is:

1. A method of recommending educational content on the basis of a user's search information by a device for analyzing a user's search information, the method comprising:
acquiring a user's search information;
acquiring a candidate webpage set on the basis of the search information;
classifying candidate webpages included in the candidate webpage set into a first webpage group and a second webpage group;
determining a target webpage on the basis of classification results; and
transmitting the determined target webpage,
wherein the classifying of the candidate webpages into the first webpage group and the second webpage group further comprises:
analyzing content of the candidate webpages through a language model;
generating a first classification question according to analysis results; and
classifying the candidate webpages into the first webpage group and the second webpage group on the basis of the generated first classification question.

2. The method of claim 1, wherein the first classification question is a question generated to minimize a difference between a number of candidate webpages classified into the first webpage group and a number of candidate webpages classified into the second webpage group.

3. The method of claim 1, wherein the generating of the first classification question comprises:
generating a first question on the basis of the analysis results and acquiring a first Gini index between the candidate webpages included in the candidate webpage set and the first question on the basis of the content of the candidate webpages;
generating a second question on the basis of the analysis results and acquiring a second Gini index between the candidate webpages included in the candidate webpage set and the second question on the basis of the content of the candidate webpages; and
comparing the first Gini index and the second Gini index and determining any one of the first question and the second question as the first classification question on the basis of a comparison result.

4. The method of claim 3, wherein the determining of any one of the first question and the second question as the first classification question further comprises determining a question corresponding a Gini index having a larger value between the first Gini index and the second Gini index as the first classification question.

5. The method of claim 1, wherein the classifying of the candidate webpages into the first webpage group and the second webpage group on the basis of the generated first classification question further comprises:
calculating whether the content of the candidate webpages corresponds to the generated first classification question through next token prediction; and
classifying the candidate webpages into the first webpage group when the content of the candidate webpages corresponds to the generated first classification question, and classifying the candidate webpages into the second webpage group when the content of the candidate webpages does not correspond to the generated first classification question.

6. The method of claim 1, wherein the determining of the target webpage on the basis of the classification results comprises:
generating a second classification question according to analysis results of content of candidate webpages included in the first webpage group;
classifying the candidate webpages included in the first webpage group into a third webpage group and a fourth webpage group on the basis of the generated second classification question; and
determining a candidate webpage included in any one of the third webpage group and the fourth webpage group as the target webpage on the basis of classification results.

7. The method of claim 6, wherein the second classification question is a question generated to minimize a difference between a number of candidate webpages classified into the third webpage group and a number of candidate webpages classified into the fourth webpage group.

8. A computer-readable recording medium on which a program for causing a computer to execute a method according to claim 1 is recorded.

9. A device for recommending educational content to be provided to a user after receiving the user's search information from a user terminal and determining a target webpage on the basis of the user's search information, the device comprising:
a transceiver configured to communicate with the user terminal; and
a controller configured to acquire the user's search information through the transceiver and determine the target webpage on the basis of the search information,
wherein the controller acquires the user's search information, acquires a candidate webpage set on the basis of the search information, classifies candidate webpages included in the candidate webpage set into a first webpage group and a second webpage group, determines the target webpage on the basis of classification results, and transmits the determined target webpage, and
in order to classify the candidate webpages included in the candidate webpage set into the first webpage group and the second webpage group, the controller analyzes content of the candidate webpages through a language model, generates a classification question according to analysis results, and classifies the candidate webpages into the first webpage group and the second webpage group on the basis of the generated classification question.
